(19) United States
(12) Patent Application Publication
(10) Pub. No.: US 2022/0126234 A1
(43) Pub. Date: Apr. 28, 2022

(54) PARTICULATE MATTER COLLECTOR

(71) Applicants: Samsung Electronics Co., Ltd., Suwon-si (KR); IUCF-HYU (Industry-University Cooperation Foundation Hanyang University), Seoul (KR)

(72) Inventors: Joonseon Jeong, Seoul (KR); Hyoungwoo Choi, Hwaseong-si (KR); Jinkyu Kang, Hwaseong-si (KR); Hyun Chul Lee, Hwaseong-si, (KR); Ikhyun An, Seoul (KR); Sejin Yook, Seoul (KR)

(21) Appl. No.: 17/355,417

(22) Filed: Jun. 23, 2021

(30) Foreign Application Priority Data
Oct. 27, 2020 (KR) 10-2020-0140696

(51) Int. Cl. B01D 47/06; B01D 46/10; B01D 50/00

(52) U.S. Cl. CPC B01D 47/06; B01D 50/002; B01D 46/10

(57) ABSTRACT

A particulate matter collector includes: a droplet spray portion which spray water into a duct through which air including particulate matter flows to collect particulate matter in the air; and a dust collection unit including a porous member which collect droplets including the particulate matter, wherein a surface of the porous member is hydrophobically treated such that water may be easily separated from the surface of the porous member.

### CROSS-REFERENCE TO RELATED APPLICATION

This application claims priority to Korean Patent Application No. 10-2020-0140696, filed on Oct. 27, 2020, and all the benefits accruing therefrom under 35 U.S.C. § 119, the content of which in its entirety is herein incorporated by reference.

### BACKGROUND

### 1. Field

The present disclosure relates to apparatuses for collecting particulate matter in a gas.

### 2. Description of Related Art

A particulate matter collector collects particulate matter in a gas, for example, air, to purify the air. The particulate matter collector may be applied to industrial dust collection facilities, air conditioning/ventilation systems in buildings, or the like.

A representative method used to remove particulate matter in air is a filtration method. A filtration method is a method of collecting particulate matter contained in air by using a filter. A filtration method removes dust with high efficiency and may filter various types of dust from the air. When an amount of particulate matter collected in the filter increases, the performance of the filter may deteriorate, and a pressure drop caused by the filter may increase. The filter may be periodically managed or replaced.

### SUMMARY

Provided are wet particulate matter collectors capable of reducing a pressure drop of a dust collection unit.

Provided are wet particulate matter collectors having improved dust collection performances.

Additional aspects will be set forth in part in the description which follows and, in part, will be apparent from the description, or may be learned by practice of the presented embodiments of the disclosure.

According to an aspect of an embodiment, a particulate matter collector includes: a duct through which air including particulate matter flows; a droplet spray portion which sprays water into the duct to form a gas-liquid mixed fluid including the water and the particulate matter in the air; and a dust collection unit including a porous member. The porous member forms a fine flow path through which the gas-liquid mixed fluid passes and collects droplets including the particulate matter, and a surface of the porous member is hydrophobic.

The porous member may include a mesh screen.

The porous member may include a porous foam block.

The porous member may include a housing and a plurality of fillers filled inside the hosing, and surfaces of the plurality of fillers are hydrophobic. The housing may be provided with an outlet through which the droplets collected on the surfaces of the plurality of fillers are discharged. The housing may include an inlet through which the gas-liquid mixed fluid is introduced and an outlet through which a reduced amount of the gas-liquid mixed fluid compared to amount of the gas-liquid mixed fluid introduced in the inlet is discharged, and a mesh screen is arranged at the inlet and the outlet. The mesh screen may be hydrophobic. Diameters of the plurality of fillers may be uniform, or the diameters of the plurality of fillers may be not uniform.

A contact angle between the water and a surface of the fine flow path may be higher than or equal to about 100 degrees)(°.

A surface of the porous member may be uneven. The porous member may include at least one of a mesh screen, a porous foam block, and a plurality of fillers filled inside a housing.

The dust collection unit may include a plurality of porous members arranged in a flow direction of the air.

According to an aspect of another embodiment, a particulate matter collector includes: a duct through which air including particulate matter flows; a droplet spray portion which sprays a liquid into the duct to collect particulate matter in the air; and a dust collection unit which forms a fine flow path through which a gas-liquid mixed fluid passes and collects droplets including the particulate matter, where the gas-liquid mixed fluid includes the liquid and the particular matter, and a surface of the fine flow path is non-affinitive with the liquid.

The surface of the fine flow path may be uneven.

The dust collection unit may include a mesh screen which forms the fine flow path. A surface of the mesh screen may be uneven.

The dust collection unit may include a porous foam block which forms the fine flow path.

The dust collection unit may include a housing and a plurality of fillers filled inside the housing to form the fine flow path, and surfaces of the plurality of fillers are non-affinitive with the liquid.

A contact angle between the liquid and the surface of the fine flow path may be greater than or equal to about 100°.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic configuration diagram of an embodiment of a particulate matter collector;

FIG. 2 shows an embodiment of a dust collection unit;

FIG. 3 shows another embodiment of a dust collection unit;

FIG. 4 is a front view of a mesh screen shown in FIG. 3;

FIG. 5 is a schematic perspective view of still another embodiment of a dust collection unit;

FIGS. 6 and 7 are perspective views showing an example of a filler;

FIGS. 8 and 9 are graphs showing a particulate removal rate of a dust collection unit including a hydrophobically treated nickel foam, wherein FIG. 8 shows a particulate removal rate for particulate matter of PM <1.0, and FIG. 9 shows a particulate removal rate for particulate matter of PM >1.0;

FIG. 10 is a graph showing a change in a pressure drop of a dust collection unit including a hydrophobically treated nickel foam;

FIGS. 11 and 12 are graphs showing a particulate removal quality factor of a dust collection unit including a hydrophobically treated nickel foam, wherein FIG. 11 shows a particulate removal quality factor for particulate matter of PM <1.0, and FIG. 12 shows a particulate removal quality factor for particulate matter of PM >1.0;

FIGS. 13 and 14 are graphs showing a particulate removal rate of a dust collection unit including a hydrophobically treated SUS 50 mesh screen, wherein FIG. 13 shows a particulate removal rate for particulate matter of PM <1.0, and FIG. 14 shows a particulate removal rate for particulate matter of PM >1.0;

FIG. 15 is a graph showing a change in pressure drop of a dust collection unit including a hydrophobically treated SUS 50 mesh screen;

FIGS. 16 and 17 are graphs showing a particulate removal quality factor of a dust collection unit including a hydrophobically treated SUS 50 mesh screen, wherein FIG. 16 shows a particulate removal quality factor for particulate matter of PM <1.0, and FIG. 17 shows a particulate removal quality factor for particulate matter of PM >1.0;

FIGS. 18 and 19 are graphs showing a particulate removal rate of a dust collection unit including an SUS 400 mesh screen that is treated to be uneven and treated to be hydrophobic, wherein FIG. 18 shows a particulate removal rate for particulate matter of PM <1.0, and FIG. 19 shows a particulate removal rate for particulate matter of PM >1.0;

FIG. 20 is a graph showing a change in pressure drop of a dust collection unit including an SUS 400 mesh screen that is treated to be uneven and treated to be hydrophobic; and

FIGS. 21 and 22 are graphs showing a particulate removal quality factor of a dust collection unit including an SUS 400 mesh screen that is treated to be uneven and treated to be hydrophobic, wherein FIG. 21 shows a particulate removal quality factor for particulate matter of PM <1.0, and FIG. 22 shows a particulate removal quality factor for particulate matter of PM >1.0.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “or” means “and/or.” As used herein, the term “and/or” includes any and all combinations of one or more of the associated listed items. Expressions such as “at least one of,” when preceding a list of elements, modify the entire list of elements and do not modify the individual elements of the list. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value. Hereinafter, embodiments of the present disclosure will be described in detail with reference to the accompanying drawings. In the following drawings, the same reference numerals refer to the same elements, and the size of each element in the drawings may be exaggerated for clarity and convenience of description.

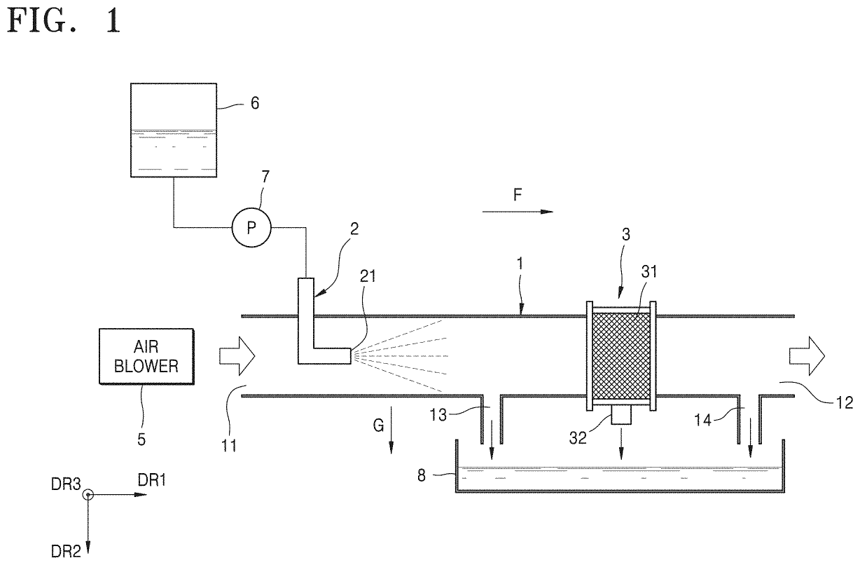

FIG. 1 is a schematic configuration diagram of an embodiment of a particulate matter collector. Referring to FIG. 1, a particulate matter collector may include a duct 1 through which air including particulate matter flows, a droplet spray portion 2 for collecting particulate matter in the air by spraying liquid into the duct 1, and a dust collection unit 3 for forming a fine flow path 31 through which a gas-liquid mixed fluid passes and for collecting droplets including the particulate matter. A surface of the fine flow path 31 is non-affinitive with liquid (e.g., hydrophobic, oleophobic). For example, a coating layer that is non-affinitive with liquid may be formed on the surface of the fine flow path 31.

The duct 1 forms an air flow path. A shape of the duct 1 according to the invention is not particularly limited. For example, the duct 1 may have a tubular shape extended in a first direction DR1, and have the air flow path therein. For example, a cross-sectional shape of the duct 1 may be various such as circular or polygonal. In another embodiment, the cross-sectional shape of the duct 1 of the present embodiment is rectangular. For example, air including particulate matter is supplied to the duct 1 through an inlet 11 by an air blower 5. Air is moved along the air flow path formed by the duct 1 and discharged through an outlet 12.

The droplet spray portion 2 may spray droplets, for example, water, into the duct 1. The droplet spray portion 2 may include one or more spray nozzles 21. For example, water stored in a water tank 6 is pressurized by a pump 7 and sprayed into the duct 1 in the form of fine droplets through the spray nozzle 21. In this process, some of particulate matter included in the air is collected in the droplets. A gas-liquid mixed fluid in which the particulate matter and droplets (e.g., water) are mixed is formed in the duct 1. The gas-liquid mixed fluid flows from the inlet 11 toward the outlet 12 along the duct 1.

The dust collection unit 3 has a plurality of fine flow paths 31. The gas-liquid mixed fluid passes through the plurality of fine flow paths 31. While the gas-liquid mixed fluid passes through the plurality of fine flow paths 31, some of droplets including particulate matter collide with and adhere to surfaces of the fine flow paths 31. Some of droplets that do not include particulate matter also collide with and adhere to the surface of the fine flow path 31. A liquid film is formed on the surface of the fine flow path 31 by the droplets. Particulate matter that is not included in droplets may contact and be collected on the liquid film formed on the fine flow path 31 while passing through the plurality of fine flow paths 31. The liquid film flows downwards along the surfaces of the fine flow paths 31 by, for example, gravity. The dust collection unit 3 may be provided with an outlet 32 for discharging the liquid flowing down from the plurality of flow paths 31. In an embodiment, the outlet 32 may be disposed at a bottom part of the dust collection unit 3. The particulate matter included in the droplets is discharged together with the droplets from the dust collection unit 3 through the outlet 32. The fine flow path 31 does not need to extend linearly in a flow direction F of air. The flow direction F may be parallel to the first direction DR1. As the fine flow path 31 is formed windingly, a contact area between the surface of the fine flow path 31 and the droplets increases, thereby easily collecting the droplets on the surface of the fine flow path 31.

At least one outlet 13 and 14 may be provided in the duct 1. When the gas-liquid mixed fluid collides with an inner wall of the duct 1, a liquid film may be formed on the inner wall of the duct 1, and particulate matter may be collected on the liquid film formed on the inner wall of the duct 1. The liquid film flows down the inner wall of the duct 1 in a gravity direction G (e.g., second direction DR2) and is discharged out of the duct 1 through the outlets 13 and 14. For example, the outlet 13 may be arranged between the droplet spray portion 2 and the dust collection unit 3. The outlet 14 may be arranged on a downstream side of the dust collection unit 3. In an embodiment, the outlets 13 and 14 may be disposed at a bottom part of the duct 1, and be extended in the second direction DR2 crossing the first direction DR1. Liquid that is discharged through the outlets 13 and 14 and the outlet 32 of the dust collection unit 3 may be stored in a collection tank 8.

While the gas-liquid mixed fluid passes through the dust collection unit 3, a pressure drop occurs. An amount of the pressure drop is a difference between pressure of an upstream side of the dust collection unit 3 and pressure of the downstream side of the dust collection unit 3 and is also referred to as differential pressure. When the differential pressure increases, energy efficiency of the particulate matter collector decreases, and operation cost increases. The liquid film collected on the surface of the fine flow path 31 may cause to narrow a cross-sectional area of the fine flow path 31, thereby increasing the differential pressure.

The increase in the differential pressure may be reduced significantly or effectively prevented by rapidly separating the liquid film from the surface of the fine flow path 31. In the present embodiment, the surface of the fine flow path 31 is made to have non-affinity characteristics (e.g., hydrophobic characteristics) with liquid sprayed from the droplet spray portion 2. Accordingly, a contact angle of droplets to the surface of the fine flow path 31 increases, thereby easily separating the droplets from the surface of the fine flow path 31. The non-affinity of the surface of the fine flow path 31 with the liquid may be represented by the contact angle of the droplets to the surface of the fine flow path 31, and the contact area of the droplets to the surface of the fine flow path 31 may be greater than or equal to 100 degrees)(°. For example, the droplet spray portion 2 may spray water in the air, and the surface of the fine flow path 31 may be treated to be hydrophobic. Hydrophobic treatment may be performed, for example, by forming a hydrophobic coating layer on the surface of the fine flow path 31. The droplet spray portion 2 may spray oil vapor into the air, and the surface of the fine flow path 31 may be treated to be oleophobic. Oleophobic treatment may be performed, for example, by forming an oleophobic coating layer on the surface of the fine flow path 31.

As described above, as the liquid is easily separated from the surface of the fine flow path 31 due to the hydrophobic characteristics of the surface of the fine flow path 31, a selection range for a porosity of the dust collection unit 3 capable of adjusting the pressure difference between the upstream side and downstream side of the dust collection unit 3, i.e., the amount of pressure drop, may widen. Accordingly, compared to an existing filtration method, an amount of pressure drop may be reduced by an embodiment according to the invention, thereby reducing energy consumption of the particulate matter collector. Also, the probability of contact among the fine flow path 31, particulate matter, and droplets may increase, and thus, high air purification efficiency may be obtained compared to the existing filtration method. In addition, as droplets in which particulate matter is collected are easily separated from the surface of the fine flow path 31, the fine flow path 31 is not blocked by stacked particulate matter even when used for a long time, unlike the existing filtration method. Therefore, the burden of the periodic management or replacement of the dust collection unit 3 may be reduced. In some cases, the dust collection unit 3 does not need to be replaced.

As an area of the surface of the fine flow path 31 that is treated to be hydrophobic is great and the contact angle may increase, the droplets may be further easily separated from the surface of the fine flow path 31. To this end, the surface of the fine flow path 31 may be treated to be uneven. The treatment to be uneven may be performed by, for example, an etching process. Hydrophobic treatment may be performed after the treatment to be uneven.

An inner structure for the fine flow path 31 according to the invention is not particularly limited. As a surface area of the fine flow path 31 increases, a contact rate between the gas-liquid mixed fluid and the surface of the fine flow path 31 may increase, and a dust collection performance of particulate matter may be improved. In an embodiment, the dust collection unit 3 may include a porous member forming the fine flow path 31. The dust collection unit 3 may include a plurality of fillers forming the fine flow path 31. Hereinafter, embodiments of the dust collection unit 3 will be described.

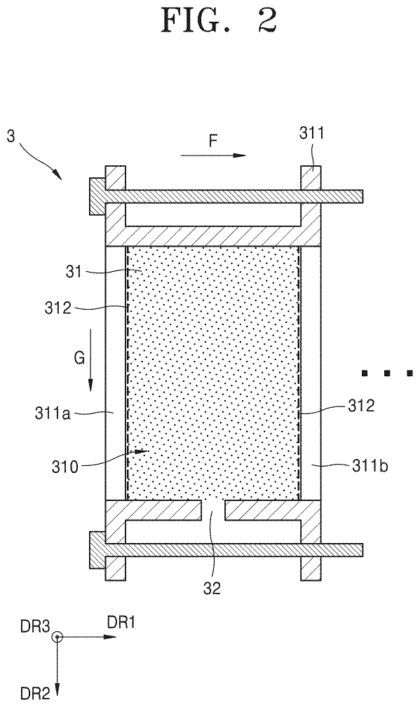

FIG. 2 shows an embodiment of the dust collection unit 3. Referring to FIG. 2, the porous member may include a porous foam member (e.g., porous foam block) 310. The porous foam member 310 may be accommodated in, for example, a housing 311. The housing 311 may have an inlet 311a and an outlet 311b which are opened in a flow direction F of a gas-liquid mixed fluid. A mesh screen 312 may be installed at the inlet 311a and the outlet 311b. The gas-liquid mixed fluid introduced into the housing 311 through the inlet 311a passes through a fine flow path 31 formed by the porous foam member 310 and is discharged through the outlet 311b with reduced amount. In this process, droplets are collected on a surface of the fine flow path 31 (e.g., porous foam member 310). The droplets fall in a gravity direction G and are discharged through an outlet 32.

The porous foam member 310 may be treated to have a non-affinity with liquid such that the droplets may be easily separated from the surface of the fine flow path 31, i.e., from the porous foam member 310. Accordingly, the surface of the fine flow path 31 formed by the porous foam member 310 becomes non-affinitive with liquid (e.g., hydrophobic, oleophobic), and the liquid may be easily separated from the surface of the fine flow path 31. For example, the porous foam member 310 may be treated to be hydrophobic. The mesh screen 312 may be treated to have a non-affinity with liquid. Accordingly, pores of the mesh screen 312 may be prevented from being blocked by liquid. Surfaces of a plurality of porous foam members 310 may be treated to be uneven before being treated to be hydrophobic to extend a hydrophobically treated surface area. The mesh screen 312 may be treated to be uneven before being treated to be hydrophobic. The porous member may include a plurality of porous foam member 310 arranged in the flow direction F of air.

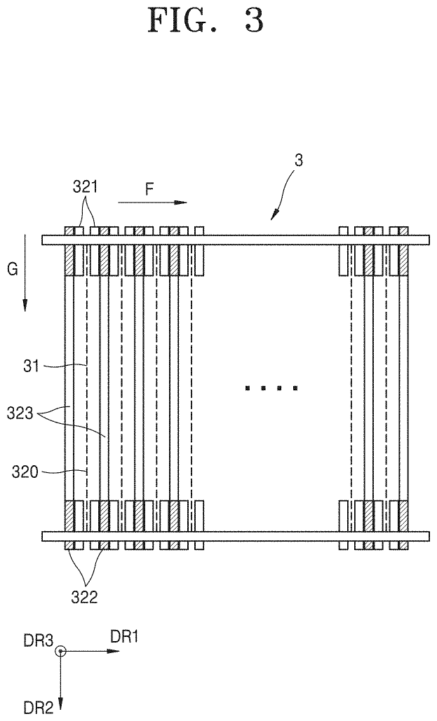

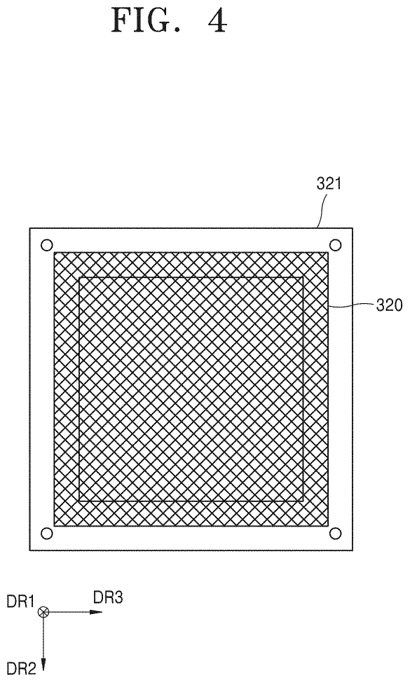

FIG. 3 shows another embodiment of the dust collection unit 3. FIG. 4 is a front view (i.e., view in the first direction DR1) of a mesh screen 320. Referring to FIGS. 3 and 4, a porous member may include the mesh screen 320. For example, the mesh screen 320 may be supported between a pair of mounting plates 322 arranged in the first direction DR1 with a pair of gaskets 321 therebetween. The mesh screen 320 may be a metal mesh screen. The mounting plate 322 is provided with an opening 323 through which a gas-liquid mixed fluid passes. The gas-liquid mixed fluid passes through a fine flow path 31 formed by the mesh screen 320. In this process, droplets are collected on a surface of the fine flow path 31. The droplets fall in a gravity direction G. The mesh screen 320 may have a non-affinity (e.g., hydrophobic, oleophobic) with the droplets so that the droplets may be easily separated from the mesh screen 320 For example, the mesh screen 320 may be treated to be hydrophobic. A porous member may include a plurality of mesh screens 320 arranged in an air flow direction F. A surface of the mesh screen 320 may be treated to be uneven before being treated to be hydrophobic to extend a hydrophobically treated surface area.

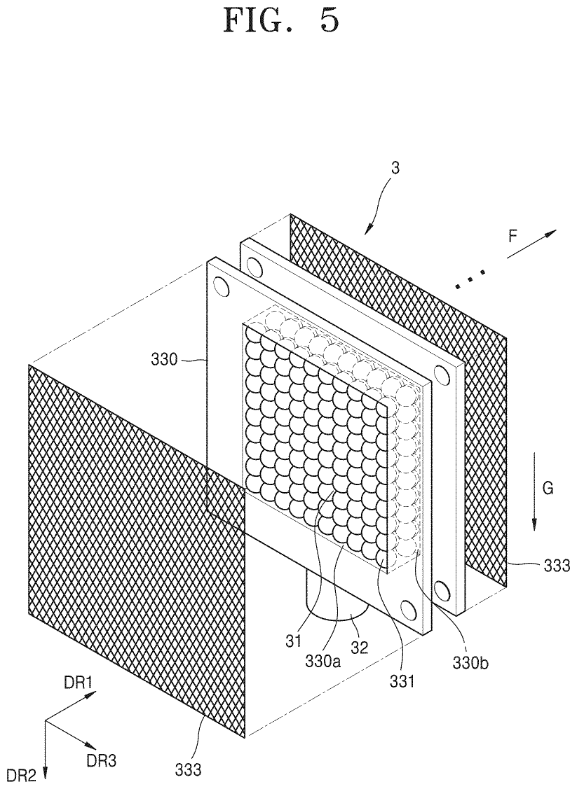

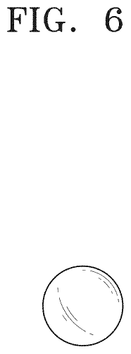

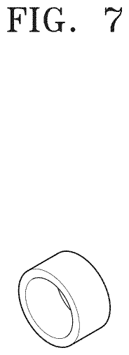

FIG. 5 is a schematic perspective view of still another embodiment of the dust collection unit 3. FIGS. 6 and 7 are perspective views showing an example of a filler 331. Referring to FIGS. 5 through 7, a porous member may include a housing 330 and a plurality of fillers 331 filled in the housing 330. A fine flow path 31 is formed by a gap between the plurality of fillers 331. The housing 330 is provided with an outlet 32 through which droplets collected on surfaces of the plurality of fillers 331 are discharged. The housing 330 may include an inlet 330a through which the gas-liquid mixed fluid including the particulate matter is introduced and an outlet 330b through which a reduced amount of the gas-liquid mixed fluid compared to amount of the gas-liquid mixed fluid introduced in the inlet 330a is discharged. A mesh screen 333 may be arranged at the inlet 330a and the outlet 330b.

The filler 331 may be, for example, a bead (See FIG. 6). The bead may be formed of, for example, glass, metal, or the like. Diameters of a plurality of beads may be uniform or nonuniform. The plurality of beads may be regularly or irregularly packed inside the housing 330. The plurality of beads may be stacked in one or more layers in a flow direction F of the gas-liquid mixed fluid. The fine flow path 31 may be defined as a void (i.e., empty space) between the plurality of beads. The bead may be a spherical bead as shown in FIG. 6. The plurality of bead may have the same diameter or different diameters. The plurality of beads may be packed inside the housing 330 in various forms. A packing form of the plurality of beads (i.e., filler 331) may be various, for example, such as a centered cubic structure such as a primitive centered cubic (“FCC”) structure, a face centered cubic (“FCC”) structure or a body centered cubic (“BCC”) structure, or a hexagonal closed-packed (“HOP”) structure. A porosity of the primitive centered cubic (PCC) structure is about 48.6 percentages (%). A porosity of the face centered cubic (FCC) structure is about 26%. A porosity of the body centered cubic (BCC) structure is about 32%. The fine flow path 31 may be defined by at least three adjacent beads. The plurality of beads may be stacked in at least two layers in the flow direction F to increase the probability of contact between the gas-liquid mixed fluid and the plurality of beads while the gas-liquid mixed fluid passes through the fine flow path 31. A cross-sectional area of the fine flow path 31 between the inlet 330a and the outlet 330b repeats contraction and expansion at least once in the flow direction F of the gas-liquid mixed fluid. In an embodiment, in a front view (i.e., view in the first direction DR1) the locations of centers of beads in one layer are different from the locations of centers of beads in the next layer such that the gas-liquid mixed fluid passes the fine flow path 31 not straight but windingly. Therefore, the probability of contact between the gas-liquid mixed fluid and the plurality of beads (i.e., filler 331) may increases, thereby improving efficiency of collecting particulate matter. The filler 331 may be a raschig ring as shown in FIG. 7. A plurality of raschig rings may be regularly or irregularly packed inside the housing 300.

The gas-liquid mixed fluid passes through the fine flow path 31 formed by the plurality of fillers 331. In this process, droplets are collected on the surface of the fine flow path 31, i.e., on the surface of the filler 331. The droplets fall in the gravity direction G. The surface of the filler 331 may be treated to have a non-affinity with the droplets such that the droplets may be easily separated from the surface of the filler 331. For example, the surface of the filler 331 may be treated to be hydrophobic. The surface of the filler 331 may be treated to be uneven before being treated to be hydrophobic to extend a hydrophobically treated surface area. The mesh screen 333 may have a non-affinity (e.g., hydrophobic, oleophobic) with liquid. Accordingly, pores of the mesh screen 333 may be prevented from being blocked by the liquid. The mesh screen 333 may be treated to be uneven before being treated to be hydrophobic to extend the hydrophobically treated surface area. A porous member may include a plurality of housings 330 arranged in the air flow direction F (i.e., the first direction DR1) and the fillers 331 filled inside the plurality of housings 330. In this case, diameters of the fillers 331 packed in the plurality of housings 330 may or may not be the same.

The performance of the particulate matter collector may be represented by a particulate removal rate E, differential pressure ΔP of the dust collection unit 3, and a particulate removal quality factor (“QF”). The particulate removal rate E may be calculated as in Equation 1 below from the number Nin of particulates included in the air before passing through the dust collection unit 3 and the number Nout of particulates included in the air after passing through the dust collection unit 3. For example, the numbers Nin and Nout may be the numbers of particulates collected for about two minutes on an upstream side and a downstream side of the dust collection unit 3, respectively. The particulate removal quality factor QF may be calculated as in Equation 2 below from the particulate removal rate E and a pressure drop of the dust collection unit 3, i.e., the differential pressure ΔP. The particulate removal quality factor QF being large indicates that particulates may be effectively removed with little energy.

$$\begin{matrix}E = \frac{( {N}_{in} - {N}_{out} )}{{N}_{in}} & ( 1 ) \\ QF = \frac{ln ( \frac{1}{1 - E} )}{Δ P} & ( 2 )\end{matrix}$$

### Experiment 1

A hydrophobically treated nickel foam, a hydrophilically treated nickel foam, and an untreated nickel foam are provided as a porous foam member 310.

Hydrophobic treatment of a nickel foam is performed as follows. A nickel foam having a thickness of 1.6 millimeters (mm) and about 80 pores per inch (ppi) to about 110 ppi is provided. About 80 ppi to about 110 ppi corresponds to about 97.5% when being converted into a porosity. The nickel foam is impregnated in an NaOH aqueous solution of 2.5 mole per liter (mol/L) having a temperature of 80 degrees in Celsius (° C.) for one hour to remove impurities on a surface of the nickel foam. 1 H, 1H, 2H, 2H-perfluoro-octyltriethoxysilance, sigma-aldrich (“PFOTES”) of 1 percentages by weight (wt %) is added to an ethanol:water mixed solution of 2:8 and agitated for one hour. The nickel foam is cut into an appropriate size, for example, a size of 100 mm×100 mm, impregnated in a solution for one hour, and dried in the air for one hour. The dried nickel foam is dried for one hour in an oven of 120° C. to remove residual solvent.

Hydrophilic treatment of a nickel foam is performed as follows. A nickel foam having a thickness of 1.6 mm and about 80 pores per inch (ppi) to about 110 ppi is provided. The nickel foam is impregnated in an NaOH aqueous solution of 2.5 mol/L having a temperature of 80° C. for one hour to remove impurities on a surface of the nickel foam. PEG-silane(2-[Methoxy (polyethyleneoxy) 6-9 propyl] trimethoxysilane, tech-90, gelest) of 1 wt % is added to an ethanol:water mixed solution of 2:8 and agitated for one hour. The nickel foam is cut into an appropriate size, for example, a size of 100 mm×100 mm, impregnated in a solution for one hour, and dried in the air for one hour. The dried nickel foam is dried in an oven of 120° C. for one hour to remove residual solvent.

The hydrophobically treated nickel foam, the hydrophilically treated nickel foam, and an untreated nickel foam are sequentially installed in the dust collection unit 3. Potassium chloride (“KCl”) particles having a size less than or equal to 3 micrometers (nm) are supplied as particulates into the duct 1 at a concentration of about 3×10⁸ pieces/cubic meter (m³) to about 3.5×10⁸ pieces/m³. The droplet spray portion 2 sprays water into the duct 1 at a volume flow rate of 0.1 liters per minute (L/min). The numbers Nin and Nout are obtained by measuring the number of particulates for two minutes on the upstream side and the downstream side of the dust collection unit 3, respectively. The differential pressure ΔP is obtained by measuring pressure on the upstream side and the downstream of the dust collection unit 3, respectively. The particulate removal rate E and the particulate removal quality factor QF are calculated by using Equations 1 and 2 above. The above experiment is performed ten times for each of the hydrophobically treated nickel foam, the hydrophilically treated nickel foam, and the untreated nickel foam.

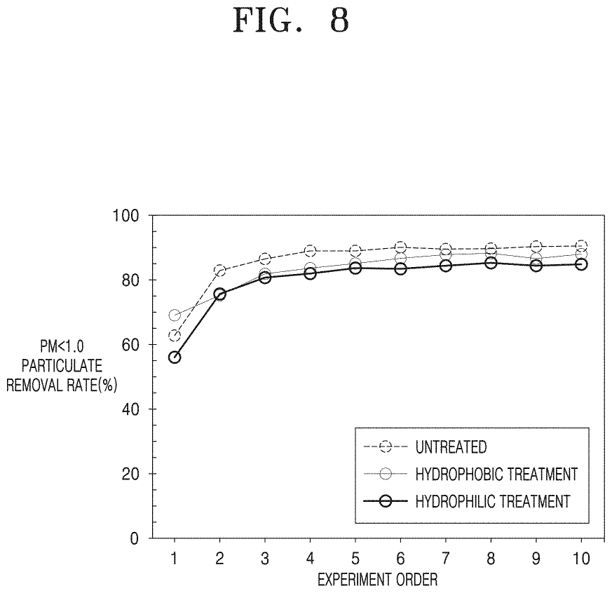

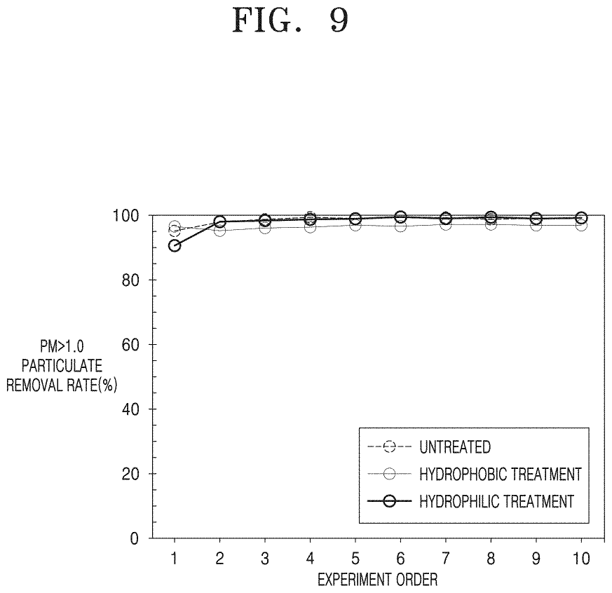

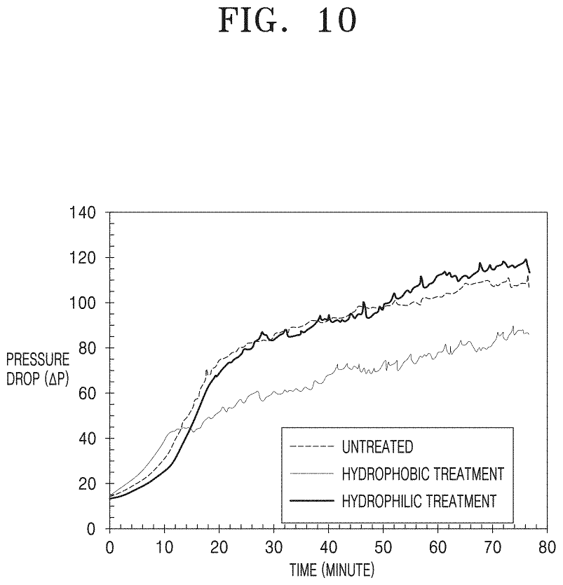

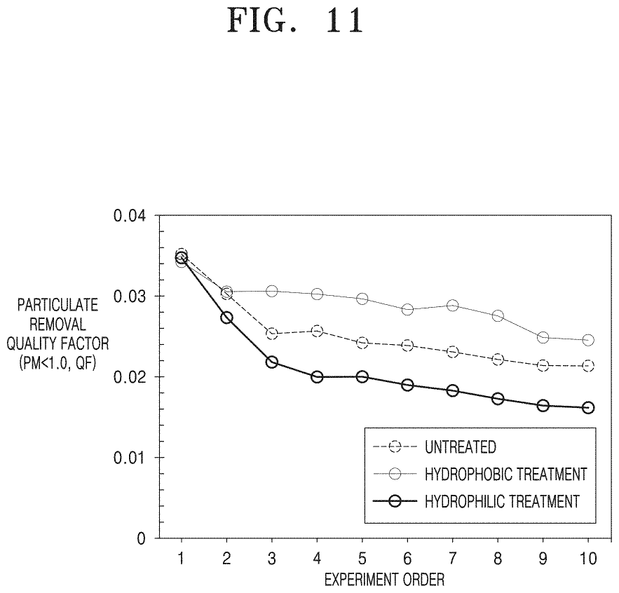

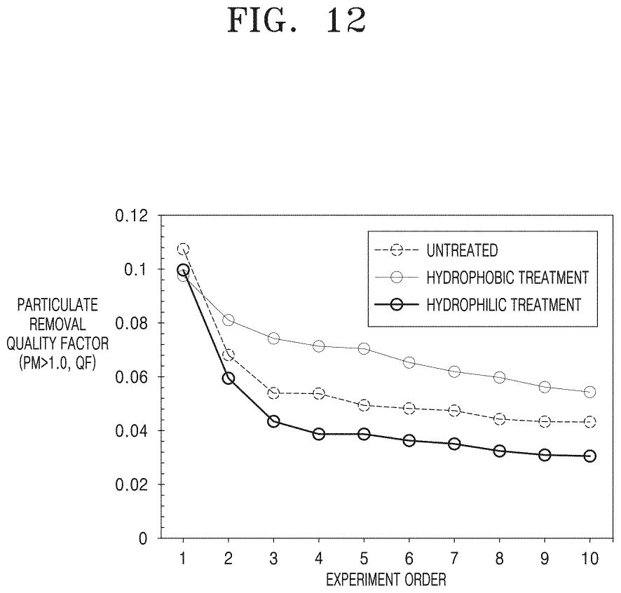

FIGS. 8 and 9 are graphs showing a particulate removal rate of the dust collection unit 3 including a hydrophobically treated nickel foam. FIG. 8 shows a particulate removal rate for particulate matter of PM <1.0 (particular matters less than 1.0 μm in diameter), and FIG. 9 shows a particulate removal rate for particulate matter of PM >1.0 (particular matters greater than 1.0 μm in diameter). FIG. 10 is a graph showing a change in pressure drop of the dust collection unit 3 including a hydrophobically treated nickel foam. FIGS. 11 and 12 are graphs showing a particulate removal quality factor of the dust collection unit 3 including a hydrophobically treated nickel foam. FIG. 11 shows a particulate removal quality factor QF for particulate matter of PM <1.0, and FIG. 12 shows a particulate removal quality factor QF for particulate matter of PM >1.0.

Referring to FIG. 8, a particulate removal rate E for particulate matter of PM <1.0 has the following relationships: untreated nickel foam >hydrophobically treated nickel foam >hydrophilically treated nickel foam. A difference in the particulate removal rate E between the hydrophobically treated nickel foam and the untreated nickel foam is within about 5%, Referring to FIG. 9, the particulate removal rate E for particulate matter of PM >1.0 is the lowest in the hydrophobically treated nickel foam and is almost similar in the hydrophilically treated nickel foam and the untreated nickel foam. Accordingly, overall, in terms of particulate removal rate E, the hydrophobically treated nickel foam is similar to or about 5% lower than the untreated nickel foam. In addition, referring FIG. 10, as an operation time (unit:minute) of the particulate matter collector elapses, a hydrophobically nickel foam shows the lowest pressure drop, and a pressure drop ΔP of a hydrophilically treated nickel foam is similar to or higher than a pressure drop ΔP of an untreated nickel foam. Referring to FIGS. 11 and 12, a particulate removal quality factor QF for particulate matter of PM >1.0 has the following relationships: hydrophobically treated nickel foam >untreated nickel foam >hydrophilically treated nickel foam. Therefore, a hydrophobically treated nickel foam may be applied to the dust collection unit 3 to implement a particulate matter collector capable of obtaining a similar particulate removal rate E to when applying an untreated nickel foam and a higher particulate removal quality factor QF than when applying the untreated nickel foam while consuming less energy.

<Experiment 2>

A hydrophobically treated SUS 50 mesh screen and an untreated SUS 50 mesh screen are provided as the mesh screen 320. A hydrophobic treatment method of an SUS 50 mesh screen is the same as in experiment 1.

The hydrophobically treated SUS 50 mesh screen and the untreated SUS 50 mesh screen are sequentially installed in the dust collection unit 3. Potassium chloride (KCl) particulates having a size less than or equal to 3 μm are supplied as particulates into the duct 1 at a concentration of about 3×10⁸ pieces/m³ to about 3.5×10⁸ pieces/m³. The droplet spray portion 2 sprays water of 0.1 L/min into the duct 1 with the untreated SUS 50 mesh screen and supplies water into the duct 1 at a volume flow rate of 0.1 L/min with the hydrophobically treated SUS 50 mesh screen, and at a volume flow rate of 0.2 L/min with the hydrophobically treated SUS 50 mesh screen, respectively. The numbers Nin and Nout are obtained by measuring the number of particulates for two minutes on the upstream side and the downstream side of the dust collection unit 3, respectively. The pressure drop ΔP is obtained by measuring pressure on the upstream side and the downstream side of the dust collection unit 3, respectively. A particulate removal rate E and a particulate removal quality factor QF are calculated by using Equations 1 and 2 above. The above experiment is performed ten times with respect to each of the untreated SUS 50 mesh screen-volume flow rate of 0.1 L/min, the hydrophobically treated SUS 50 mesh screen-volume flow rate of 0.1 L/min, and the hydrophobically treated SUS 50 mesh screen-volume flow rate of 0.2 L/min.

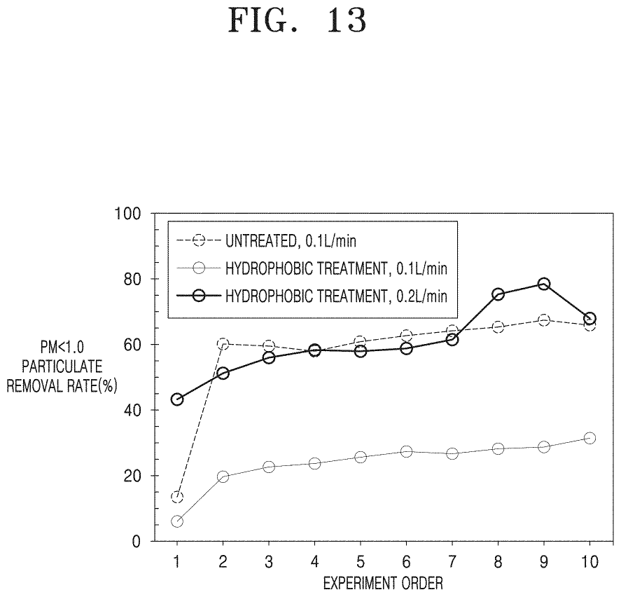

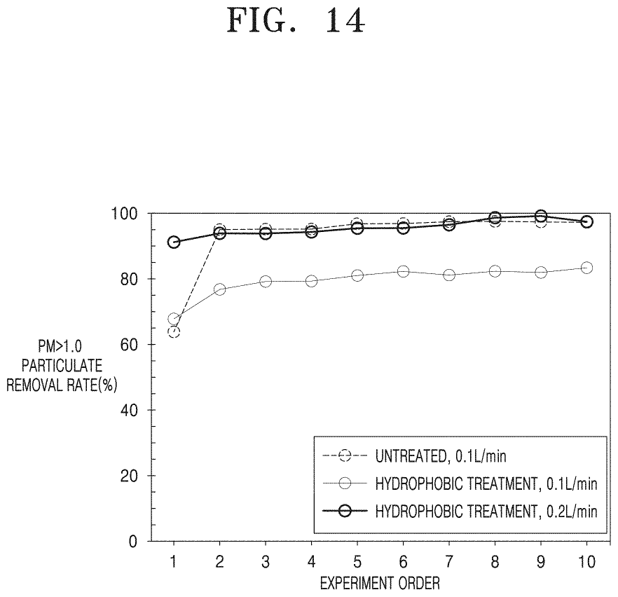

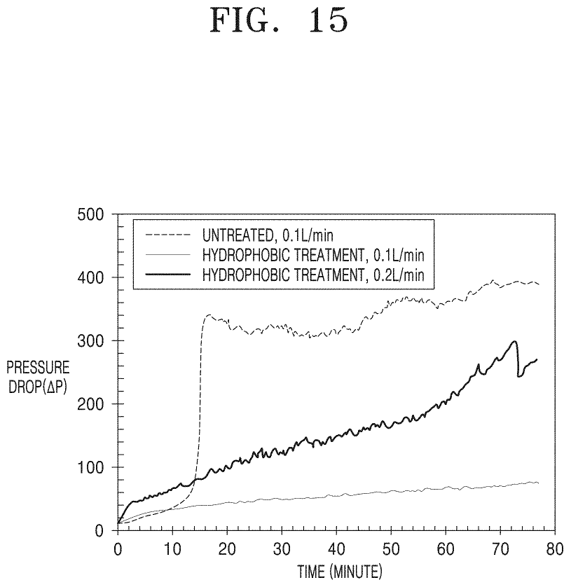

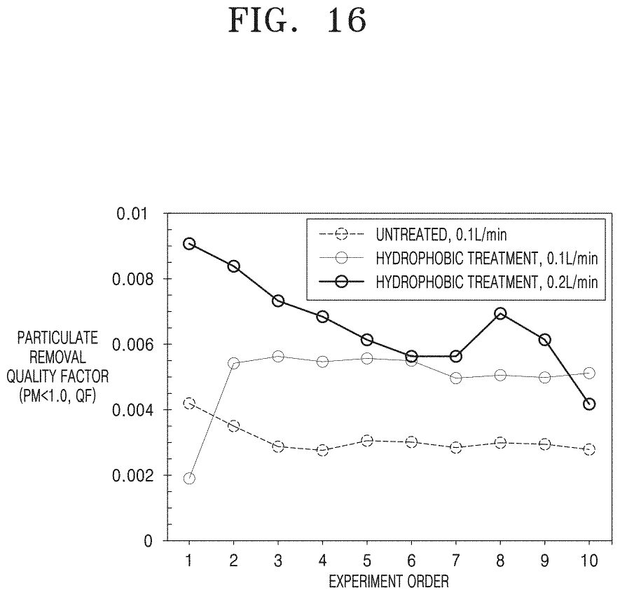

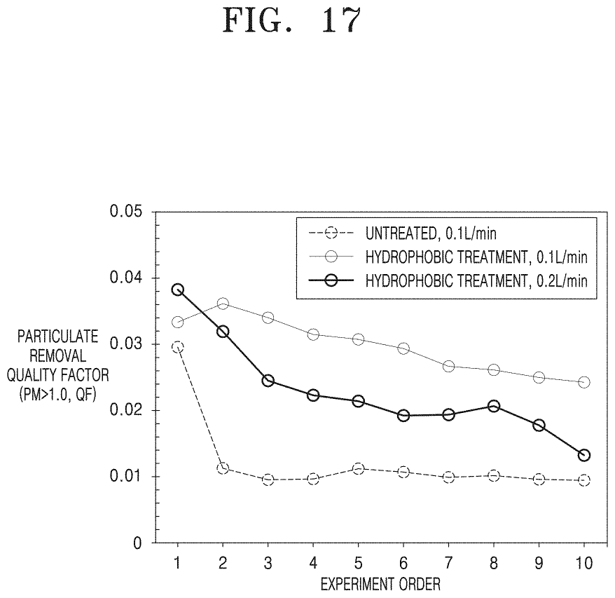

FIGS. 13 and 14 are graphs showing a particulate removal rate of the dust collection unit 3 including a hydrophobically treated SUS 50 mesh screen. FIG. 13 shows a particulate removal rate for particulate matter of PM <1.0, and FIG. 14 shows a particulate removal rate for particulate matter of PM >1.0. FIG. 15 is a graph showing a change in pressure drop of the dust collection unit 3 including a hydrophobically treated SUS 50 mesh screen. FIGS. 16 and 17 are graphs showing a particulate removal quality factor of the dust collection unit 3 including a hydrophobically treated SUS 50 mesh screen. FIG. 16 shows a particulate removal quality factor QF for particulate matter of PM <1.0, and FIG. 17 shows a particulate removal quality factor QF for particulate matter of PM >1.0.

Referring to FIG. 13, when a volume flow rate of sprayed water is the same as 0.1 L/min, a particulate removal rate E of an untreated SUS 50 mesh screen for particulate matter of PM <1.0 is higher than that of a hydrophobically treated SUS 50 mesh screen. However, when the volume flow rate of sprayed water increases to 0.2 L/min, the particulate removal rate E of the hydrophobically treated SUS 50 mesh screen for the particulate matter of PM <1.0 is equal to or becomes higher than that of the untreated SUS 50 mesh screen when a volume flow rate of sprayed water is 0.1 L/min. This is also the same in the case of the particulate removal rate E for particulate matter of PM >1.0 as shown in FIG. 14. Therefore, overall, the volume flow rate of water may increase so that a particulate removal rate E of the dust collection unit 3 applying the hydrophobically treated SUS 50 mesh screen may be equal to or higher than that of the untreated SUS 50 mesh screen. Referring to FIG. 15, the hydrophobically treated SUS 50 mesh screen shows a lower pressure drop ΔP than the untreated SUS 50 mesh screen when a volume flow rate of sprayed water is 0.1 L/min. Also, when the hydrophobically treated SUS 50 mesh screen is used, the pressure drop ΔP increases by increasing the volume flow rate of water. However, even when the volume flow rate of water increases by two times, the hydrophobically treated SUS 50 mesh screen still shows the lower pressure drop ΔP than the untreated SUS 50 mesh screen with a volume flow rate of sprayed water of 0.1 L/min. Referring to FIGS. 16 and 17, the particulate removal quality factor QF of the hydrophobically treated SUS 50 mesh screen for the particulate matter of PM >1.0 is higher than that of the untreated SUS 50 mesh screen. Therefore, the hydrophobically treated SUS 50 mesh screen may be applied to the dust collection unit 3, and the volume flow rate of water may be appropriately determined, thereby implementing a particulate matter collector capable of obtaining high particulate removal rate E and particulate removal quality factor QF while consuming less energy.

### Experiment 3

A hydrophobically treated SUS 400 mesh screen without uneven treatment, an unevenly treated and hydrophobically treated SUS 400 mesh screen, and an untreated SUS 400 mesh screen are provided as the mesh screen 320. Hydrophobic treatment of a SUS 400 mesh screen may be performed in the same method as in <Experiment 1>. Uneven treatment (pretreatment) may be performed by a chemical etching method, before hydrophobic treatment. For example, a SUS 400 mesh screen may be treated to be uneven by impregnating the SUS 400 mesh screen for one hour in mixed solution of 37% HCL:70% HNO₃:DI in a volume ratio of 3:1:30 at room temperature. A surface of the SUS 400 mesh screen is etched by the acid solution and fine nano-structures are formed in the surface of the SUS 400 mesh screen. The etched SUS 400 mesh screen is treated to be hydrophobic in the same method as in experiment 1. Thereby, a SUS 400 mesh screen with higher hydrophobicity than those of the hydrophobically treated SUS 400 mesh screen and the untreated SUS 400 screen may be obtained.

The hydrophobically treated SUS 400 mesh screen without uneven treatment, the unevenly treated and hydrophobically treated SUS 400 mesh screen, and the untreated SUS 400 mesh screen are sequentially installed in the dust collection unit 3. Potassium chloride (KCl) particulates having a size less than or equal to 3 μm are supplied as particulates into the duct 1 at a concentration of about 3×10⁸ pieces/m³ to about 3.5×10⁸ pieces/m³. The droplet spray portion 2 sprays water of 0.1 L/min into the duct 1. The numbers Nin and Nout are obtained by measuring the number of particulates for two minutes on the upstream side and the downstream side of the dust collection unit 3, respectively. The pressure drop ΔP is obtained by measuring pressure on the upstream side and the downstream side of the dust collection unit 3, respectively. A particulate removal rate E and a particulate removal quality factor QF are calculated by using Equations 1 and 2 above. The above experiment is performed four times for each of the hydrophobically treated SUS 400 mesh screen without uneven treatment, the unevenly treated and hydrophobically treated SUS 400 mesh screen, and the untreated 400 mesh screen.

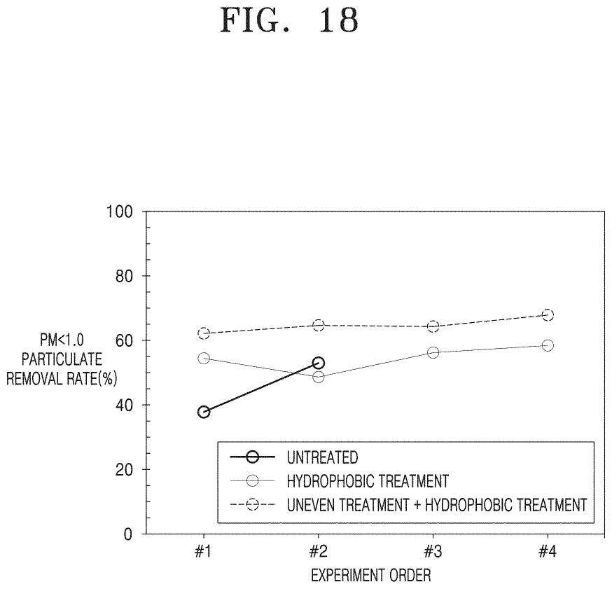

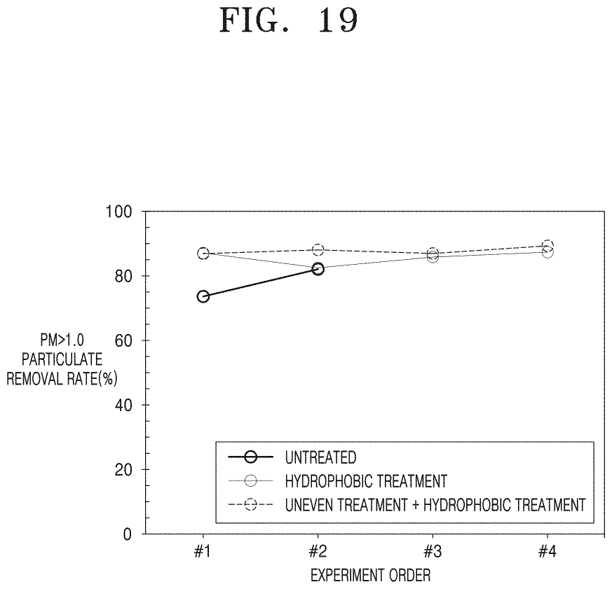

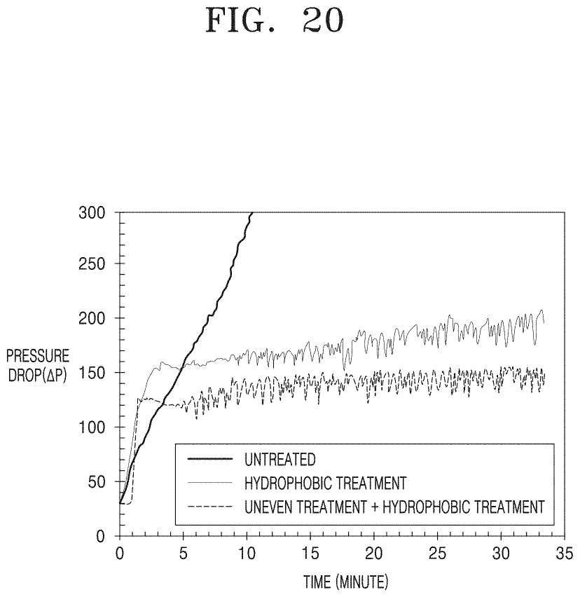

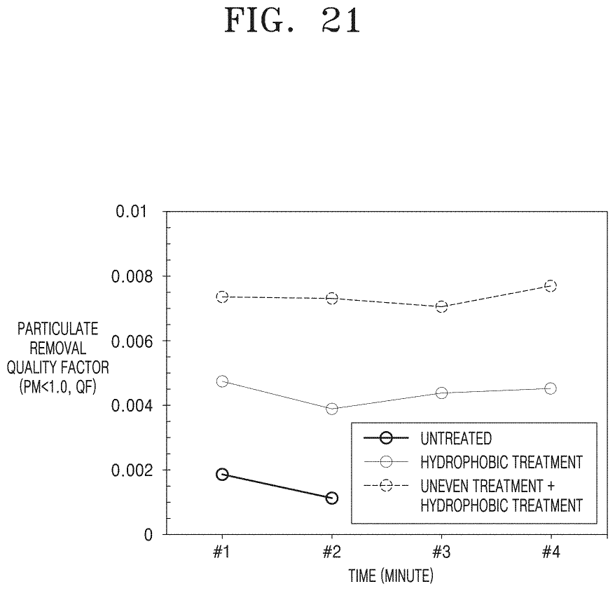

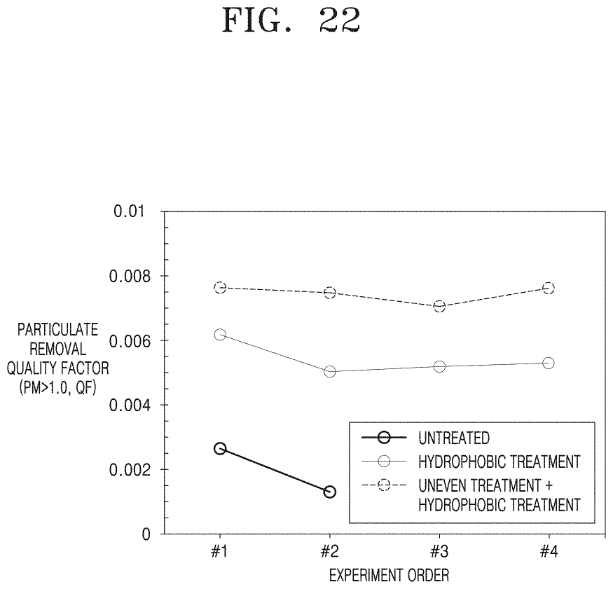

FIGS. 18 and 19 are graphs showing a particulate removal rate of the dust collection unit 3 including an unevenly treated and hydrophobically treated SUS 400 mesh screen. FIG. 18 shows a particulate removal rate for particulate matter of PM <1.0, and FIG. 19 shows a particulate removal rate for particulate matter of PM >1.0. FIG. 20 is a graph showing a change in pressure drop of the dust collection unit 3 including an unevenly treated and hydrophobically treated SUS 400 mesh screen. FIGS. 21 and 22 are graphs showing a particulate removal quality factor of the dust collection unit 3 including an unevenly treated and hydrophobically treated SUS 400 mesh screen. FIG. 21 shows a particulate removal quality factor QF for particulate matter of PM <1.0, and FIG. 22 shows a particulate removal quality factor QF for particulate matter of PM >1.0.

Referring to FIGS. 18 and 19, the particulate removal rate E of the unevenly treated and hydrophobically treated SUS 400 mesh screen for particulate matter of PM >1.0 is higher than those of the hydrophobically treated SUS 400 mesh screen without uneven treatment and the untreated SUS 400 mesh screen. This is because an area of the hydrophobically treated surface increases by increasing surface roughness and surface area of a SUS 400 mesh screen due to uneven treatment prior to a hydrophobic treatment. When the area of the hydrophobically treated surface increases, a hydrophobicity of the SUS 400 mesh may increase, droplets may be easily separated from the surface of the SUS 400 mesh screen, and thereby increasing the particulate removal rate E. Actually, when measuring a surface contact angle, the surface contact angle increases in the order of the untreated SUS 400 mesh screen, the hydrophobically treated SUS 400 mesh screen without uneven treatment, and the unevenly treated and hydrophobically treated SUS 400 mesh screen. Referring to FIG. 20, the hydrophobically treated SUS 400 mesh screen without uneven treatment shows a lower pressure drop than the untreated SUS 400 mesh screen. The unevenly treated and hydrophobically treated SUS 400 mesh screen shows a lower pressure drop than the hydrophobically treated SUS 400 mesh screen without uneven treatment. Referring to FIGS. 21 and 22, a particulate removal quality factor QF of the hydrophobically treated SUS 400 mesh screen without uneven treatment for particulate matter of PM >1.0 is higher than that of the untreated SUS 400 mesh screen, and a particulate removal quality factor QF of the unevenly treated and hydrophobically treated SUS 400 mesh screen is higher than that of the hydrophobically treated SUS 400 mesh screen without uneven treatment. Accordingly, an unevenly treated and hydrophobically treated SUS 400 mesh screen may be applied to the dust collection unit 3, thereby implementing a particulate matter collector capable of obtaining high particulate removal rate E and particulate removal quality factor QF while consuming less energy.

According to embodiments of a particulate matter collector as described above, droplets including particulate matter may be collected in a dust collection unit and then may be easily discharged from the dust collection unit, thereby reducing differential pressure in the dust collection unit, i.e., an amount of pressure drop while passing through the dust collection unit. Accordingly, energy consumption of the particulate matter collector may be reduced. Particulate matter in the air may be collected in the droplets and filtered, and thus, a high dust collection performance may be implemented. The droplets in which the particulate matter is collected may be easily discharged from the dust collection unit, thereby reducing the burden of periodic management or replacement of the dust collection unit.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A particulate matter collector comprising:
a duct through which air including particulate matter flows;
a droplet spray portion which sprays water into the duct to form a gas-liquid mixed fluid including the water and the particulate matter in the air; and
a dust collection unit including a porous member,
wherein the porous member forms a fine flow path through which the gas-liquid mixed fluid passes and collects droplets including the particulate matter, and
a surface of the porous member is hydrophobic.

2. The particulate matter collector of claim 1, wherein the porous member includes a mesh screen.

3. The particulate matter collector of claim 1, wherein the porous member includes a porous foam block.

4. The particulate matter collector of claim 1, wherein
the porous member includes a housing and a plurality of fillers filled inside the hosing, and
surfaces of the plurality of fillers are hydrophobic.

5. The particulate matter collector of claim 4, wherein the housing is provided with an outlet through which the droplets collected on the surfaces of the plurality of fillers are discharged.

6. The particulate matter collector of claim 4, wherein
the housing includes an inlet through which the gas-liquid mixed fluid is introduced and an outlet through which a reduced amount of the gas-liquid mixed fluid compared to amount of the gas-liquid mixed fluid introduced in the inlet is discharged, and
a mesh screen is arranged at the inlet and the outlet.

7. The particulate matter collector of claim 6, wherein the mesh screen is hydrophobic.

8. The particulate matter collector of claim 4, wherein diameters of the plurality of fillers are uniform.

9. The particulate matter collector of claim 4, wherein diameters of the plurality of fillers are not uniform.

10. The particulate matter collector of claim 1, wherein a contact angle between the water and a surface of the fine flow path is higher than or equal to about 100 degrees)(°.

11. The particulate matter collector of claim 1, wherein a surface of the porous member is uneven.

12. The particulate matter collector of claim 11, wherein the porous member includes at least one of a mesh screen, a porous foam block, and a plurality of fillers filled inside a housing.

13. The particulate matter collector of claim 1, wherein the dust collection unit includes a plurality of porous members arranged in a flow direction of the air.

14. A particulate matter collector comprising:
a duct through which air including particulate matter flows;
a droplet spray portion which sprays a liquid into the duct to collect particulate matter in the air; and
a dust collection unit which forms a fine flow path through which a gas-liquid mixed fluid passes and collects droplets including the particulate matter, wherein the gas-liquid mixed fluid includes the liquid and the particular matter, and
a surface of the fine flow path is non-affinitive with the liquid.

15. The particulate matter collector of claim 14, wherein the surface of the fine flow path is uneven.

16. The particulate matter collector of claim 14, wherein the dust collection unit includes a mesh screen which forms the fine flow path.

17. The particulate matter collector of claim 16, wherein a surface of the mesh screen is uneven.

18. The particulate matter collector of claim 14, wherein the dust collection unit includes a porous foam block which forms the fine flow path.

19. The particulate matter collector of claim 14, wherein
the dust collection unit includes a housing and a plurality of fillers filled inside the housing to form the fine flow path, and
surfaces of the plurality of fillers are non-affinitive with the liquid.

20. The particulate matter collector of claim 14, wherein a contact angle between the liquid and the surface of the fine flow path is greater than or equal to about 100°.
